(19) United States
(12) Patent Application Publication
(10) Pub. No.: US 2023/0308829 A1
(43) Pub. Date: Sep. 28, 2023

(54) Searching For Local Establishments Based On Content Presented

(71) Applicant: Google LLC, Mountain View, CA (US)

(72) Inventors: Mariam Khaled Dabboussi, Dubai (AE); Jonathan Sidi, New York, NY (US); Basel Hijazi, Dubai (AE)

(21) Appl. No.: 18/127,037

(22) Filed: Mar. 28, 2023

Related U.S. Application Data
(60) Provisional application No. 63/324,397, filed on Mar. 28, 2022.

(51) Int. Cl. H04W 4/021; G06F 16/29; G01C 21/36; G06Q 30/018

(52) U.S. Cl. CPC H04W 4/021; G06F 16/29; G01C 21/3682; G06Q 30/018

(57) ABSTRACT

The present disclosure provides for searching and identifying establishments based on content to be presented at the establishment. For example, businesses can add attributes to a business profile, the attributes indicating sports, leagues, teams, matches, etc. that the business will display. The attributes may be searchable by a user, such as through a search engine application, a maps application, or other application. In this regard, the user can quickly identify a business in a selected region that will be playing what the user wants to watch.

### CROSS-REFERENCE TO RELATED APPLICATIONS

The present application claims the benefit of the filing date of U.S. Provisional Patent Application No. 63/324,397, filed Mar. 28, 2022, the disclosure of which is hereby incorporated herein by reference.

### BACKGROUND

Watching sports is often a group activity, where fans come together to cheer on their favorite team at bars, restaurants, or other establishments that are showing a televised sporting event. This is especially true for sporting events or tournaments that require a dedicated subscription to watch. However, it can be difficult to find a sports bar that broadcasts the right sport, league, tournament, game/match or team that a person wants to watch. In some regions, there are bars that are dedicated to a specific sports, such as baseball or football. In other regions, some bars broadcast certain leagues, such as La Liga, Champions League, Premier League, etc., since they run in the same time periods. However, it is difficult and time consuming for users to find the right sports bar, as they typically need to sort through reviews or other content for each establishment to get a sense of what that establishment typically plays, an even then the only way to be sure what the establishment will be playing is likely to call and ask.

### BRIEF SUMMARY

The present disclosure provides for searching and identifying establishments based on content to be presented at the establishment. For example, businesses can add attributes to a business profile, the attributes indicating sports, leagues, teams, matches, etc. that the business will display. The attributes may be searchable by a user, such as through a search engine application, a maps application, or other application. In this regard, the user can quickly identify a business in a selected region that will be playing what the user wants to watch. For example, if a user enters a query intended to find local pubs or restaurants playing a specific sports game between two teams, wherein the sports game is scheduled to be televised at a given time, the user may be provided with one or more results identifying establishments that will be playing the specific sports game as it airs. In some examples the results may also list, for each establishment, other sports games or events that will be played at the scheduled time or at other times as well.

One aspect of the disclosure provides a method, comprising receiving, with one or more processors, a user request for a specific sporting event to be presented at establishments within a particular geographic region; receiving, with the one or more processors, information from the establishments within the particular geographic region, the information for each establishment indicating which sporting events will be presented at the respective establishment; updating, with the one or more processors, a respective business profile for the respective establishments based on the information; identifying, with the one or more processors, matching establishments in the particular geographic region, wherein the business profile for each of the matching establishments indicates that the specific sporting event will be presented; and providing for display, with the one or more processors, search results indicating the matching establishments and the specific sporting event to be presented.

According to some examples, the sporting event may be broadcast through a television network or streaming service. The content may be, for example, at least one of live in-person events, live virtual events, time delayed or replayed events. The live virtual events may be televised or streamed events.

According to some examples, receiving the information from the establishments may include transmitting, with the one or more processors, a content request message to one or more of the establishments; and receiving, with the one or more processors, a response to the content request message.

According to some examples, providing the search results for display may include providing a graphic for each result as an overlay on a map. The graphic may include information indicating the specific sporting event to be presented at the establishment.

According to some examples, the method may further include automatically updating the respective business profile based on the sporting event to be presented at the respective establishment. Such automatic updating may include removing sporting events from a portion of the business profile listing sporting event to be presented, wherein the removing is performed after the sporting event has ended.

Another aspect of the disclosure provides a system, comprising one or more memories and one or more processors in communication with the one or more memories. The one or more processors may be configured to receive a user request for a specific sporting event to be presented at establishments within a particular geographic region; receive information from the establishments within the particular geographic region, the information for each establishment indicating which sporting events will be presented at the respective establishment; update a respective business profile for the respective establishments based on the information; identify matching establishments in the geographic region, wherein the business profile for each of the matching establishments indicates that the specific sporting event will be presented; and provide for display search results indicating the matching establishments and the specific sporting event to be presented.

Providing the search results for display may include providing a graphic for each result as an overlay on a map. The graphic may include information indicating the specific sporting event to be presented at the establishment.

According to some examples, the content may include at least one of live in-person events, live virtual events, time delayed or replayed events. The live virtual events may be televised or streamed events.

According to some examples, the one or more processors may be further configured to automatically update the respective business profile based on the sporting event to be presented at the respective establishment. This may include updating the respective business profile comprises removing sporting events from a portion of the business profile listing sporting event to be presented, wherein the removing is performed after the sporting event has ended.

In receiving the information from the establishments the one or more processors may be further configured to transmit a content request message to one or more of the establishments; and receive a response to the content request message.

Yet another aspect of the disclosure provides a computer-readable medium storing instructions executable by one or more processors for performing a method, comprising receiving a user request for a specific sporting event to be presented at establishments within a particular geographic region; receiving information from the establishments within the particular geographic region, the information for each establishment indicating which sporting events will be presented at the respective establishment; updating a respective business profile for the respective establishments based on the information; identifying matching establishments in the particular geographic region, wherein the business profile for each of the matching establishments indicates that the specific sporting event will be presented; and providing for display search results indicating the matching establishments and the specific sporting event to be presented.

Providing the search results for display may include providing a graphic for each result as an overlay on a map, wherein the graphic includes information indicating the specific sporting event to be presented at the establishment.

According to some examples, the method performed upon executing the instructions may further include automatically updating the respective business profile based on the sporting event to be presented at the respective establishment, wherein automatically updating the respective business profile comprises removing sporting events from a portion of the business profile listing sporting event to be presented, wherein the removing is performed after the sporting event has ended.

### BRIEF DESCRIPTION OF THE DRAWINGS

FIG. 1A is a block diagram of an example system according to aspects of the disclosure.

FIG. 1B is a pictorial diagram of the example system of FIG. 1A.

FIG. 2 is a pictorial diagram of an example user interface according to aspects of the disclosure.

FIG. 3 is a flow diagram illustrating an example method according to aspects of the disclosure.

FIG. 4 is an example screenshot illustrating an example business attributes page according to aspects of the disclosure.

FIG. 5 is an example screenshot illustrating another example business attributes page according to aspects of the disclosure.

FIG. 6 is an example screenshot illustrating an example search and results for content to be played at establishments according to aspects of the disclosure.

FIG. 7 is an example screenshot illustrating another example search and results for content to be played at establishments according to aspects of the disclosure.

FIG. 8 is an example screenshot illustrating another example search and results for content to be played at establishments according to aspects of the disclosure.

FIG. 9A is an example screenshot illustrating an example search for content according to aspects of the disclosure.

FIG. 9B is an example screenshot illustrating example results for content to be plated at establishments according to aspects of the disclosure.

FIG. 10 is a flow diagram illustrating an example method according to aspects of the disclosure.

### DETAILED DESCRIPTION

The present disclosure provides for efficiently identifying content to be played at an establishment. Examples of such content may include televised content, such as sporting events, award shows, performances, national events or ceremonies, etc. Other examples may include broadcast audio events, such as podcasts, music performances, etc., or any other type of content. For example, the establishments within a geographical area may provide information indicating what specific content will be played. The information may be provided, for example, by a dedicated communication link, through a business profile updated by an authorized representative of the establishment, through automated calls, etc. A business listing for the establishment may be updated based on the information, such that search results for where the content will be played can include the establishment. By way of example, if a multi-game or multi-event sporting contest, such as the Olympics, World Cup, etc., is occurring, the user can search for and readily identify which local establishments will be playing specific events or games of the contest at the establishment. For example, the user can identify which local bar will display a specific Olympic event or World Cup match between two teams.

The content that will be played may be indicated in a business profile for the establishment, such that it is searchable and easily accessible to a user. For example, the business profile may include a list, schedule, or any other indication of the content to be played. Verified merchants globally would be able to add such information to their business profiles to publicize that they are streaming a sports match/game/tournament. Such information may be searchable, such that a user can easily find establishments playing content that the user wants to see or hear. For example, the user may ask “Where do I watch the match today?” In response, search results may be returned identifying establishments where specific sports matches are being played. The results may be provided in, for example, a list, map, audibly via an assistant or the like, or in any other format. The results may be filtered based on any of a variety of parameters, such as geographic region, other attributes of the establishment, explicit or implicit user preferences, etc.

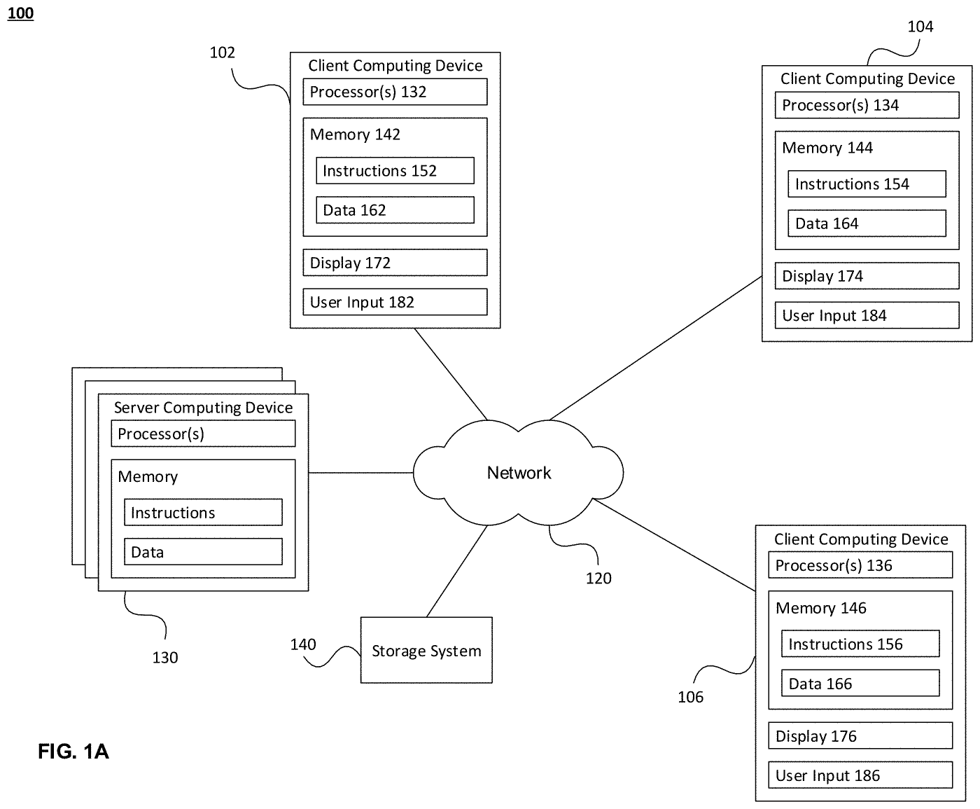

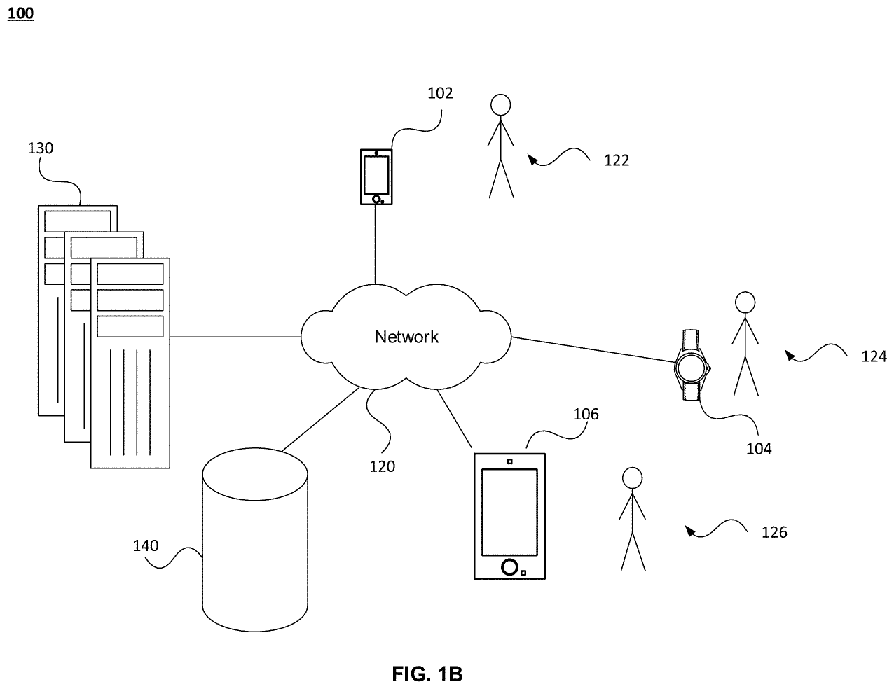

FIG. 1A illustrates an example system 100 in which the features described above may be implemented. It should not be considered limiting the scope of the disclosure or usefulness of the features described herein. In this example, system 100 may include a plurality of devices 102, 104, 106, server computing device 130, storage system 140, and network 120.

Each of devices 102, 104, 106 may include one or more processors 132, 134, 136, memory 142, 144, 146, data 162, 164, 166 and instructions 152, 154, 156. Each of devices 102, 104, 106 may also display 172, 174, 176 and user input 182, 184, 186.

Memory 142, 144, 146 of devices 102, 104, 106 may store information that is accessible by processor 132, 134, 136. Memory 142, 144, 146 may also include data that can be retrieved, manipulated or stored by the processor 132, 134, 136. The memory 142, 144, 146 may be of any non-transitory type capable of storing information accessible by the processor 132, 134, 136, including a non-transitory computer-readable medium, or other medium that stores data that may be read with the aid of an electronic device, such as a hard-drive, memory card, read-only memory (“ROM”), random access memory (“RAM”), optical disks, as well as other write-capable and read-only memories. Memory 142, 144, 146 may store information that is accessible by the processors 132, 134, 136, including instructions 152, 154, 156 that may be executed by processors 132, 134, 136, and data 162, 164, 166.

Data 162, 164, 166 may be retrieved, stored or modified by processors 132, 134, 136 in accordance with instructions 152, 154, 156. For instance, although the present disclosure is not limited by a particular data structure, the data 162, 164, 166 may be stored in computer registers, in a relational database as a table having a plurality of different fields and records, XML documents, or flat files. The data 162, 164, 166 may also be formatted in a computer-readable format such as, but not limited to, binary values, ASCII or Unicode. By further way of example only, the data 162, 164, 166 may comprise information sufficient to identify the relevant information, such as numbers, descriptive text, proprietary codes, pointers, references to data stored in other memories (including other network locations) or information that is used by a function to calculate the relevant data.

The instructions 152, 154, 156 can be any set of instructions to be executed directly, such as machine code, or indirectly, such as scripts, by the processor 132, 134, 136. In that regard, the terms “instructions,” “application,” “steps,” and “programs” can be used interchangeably herein. The instructions can be stored in object code format for direct processing by the processor, or in any other computing device language including scripts or collections of independent source code modules that are interpreted on demand or compiled in advance. Functions, methods and routines of the instructions are explained in more detail below.

The one or more processors 132, 134, 136 may include any conventional processors, such as a commercially available CPU or microprocessor. Alternatively, the processor can be a dedicated component such as an ASIC or other hardware-based processor. Although not necessary, computing devices 102, 104, 106 may include specialized hardware components to perform specific computing functions faster or more efficiently.

Although FIG. 1A functionally illustrates the processor, memory, and other elements of computing devices 102, 104, 106 as being within the same respective blocks, it will be understood by those of ordinary skill in the art that the processor or memory may actually include multiple processors or memories that may or may not be stored within the same physical housing. Similarly, the memory may be a hard drive or other storage media located in a housing different from that of the computing devices 102, 104, 106. Accordingly, references to a processor or computing device will be understood to include references to a collection of processors or computing devices or memories that may or may not operate in parallel.

Display 172, 174, 176 and other displays described herein may be any type of display, such as a monitor having a screen, a touch-screen, a projector, or a television. The display 172, 174, 176 of the one or more computing devices 102, 104, 106 may electronically display information to a user via a graphical user interface (“GUI”) or other types of user interfaces. For example, as will be discussed below, display 172, 174, 176 may electronically display a map interface with turn-by-turn directions between two geographic locations, corresponding road segments, and waypoints to maximize the overall probability of finding an open parking spot when searching in a predefined area surrounding the final geographic location.

The user inputs 182, 184, 186 may be a mouse, keyboard, touch-screen, microphone, or any other type of input.

The devices 102, 104, 106 can be at various nodes of a network 120 and capable of directly and indirectly communicating with other nodes of network 120. Although three (3) computing devices are depicted in FIG. 1A, it should be appreciated that a typical system can include one or more computing devices, with each computing device being at a different node of network 120. The network 120 and intervening nodes described herein can be interconnected using various protocols and systems, such that the network can be part of the Internet, World Wide Web, specific intranets, wide area networks, or local networks. The network 120 can utilize standard communications protocols, such as WiFi or Bluetooth, that are proprietary to one or more companies. Although certain advantages are obtained when information is transmitted or received as noted above, other aspects of the subject matter described herein are not limited to any particular manner of transmission.

In one example, system 100 may include one or more server computing devices having a plurality of computing devices, e.g., a load balanced server farm, that exchange information with different nodes of a network for the purpose of receiving, processing and transmitting the data to and from other computing devices. For instance, one or more server computing devices 130 may be a web server that is capable of communicating with the one or more client computing devices 102, 104, 106 via the network 120. In addition, server computing device 130 may use network 120 to transmit and present information to a user of one of the other computing devices 102, 104, 106. Server computing device 130 may include one or more processors, memory, instructions, and data. These components operate in the same or similar fashion as those described above with respect to computing devices 102, 104, 106.

As shown in FIG. 1B, each device 102, 104, 106 may be a personal computing device intended for use by a respective user 122, 124, 126, and have all of the components normally used in connection with a personal computing device including a one or more processors (e.g., a central processing unit (CPU)), memory (e.g., RAM and internal hard drives) storing data and instructions, a display (e.g., a monitor having a screen, a touch-screen, a projector, a television, or other device such as a smart watch display that is operable to display information), and user input devices (e.g., a mouse, keyboard, touchscreen or microphone). The devices may also include a camera for recording video streams, speakers, a network interface device, and all of the components used for connecting these elements to one another. Devices 102, 104, 106 may be capable of wirelessly exchanging or obtaining data over the network 120.

Although the client computing devices may each comprise a full-sized personal computing device, they may alternatively comprise mobile computing devices capable of wirelessly exchanging data with a server over a network such as the Internet. By way of example only, devices 102, 104, and 106 may be mobile phones or devices such as a wireless-enabled PDA, smartphones, a tablet PC, a wearable computing device (e.g., a smartwatch, AR/VR headset, smart helmet, etc.), or a netbook that is capable of obtaining information via the Internet or other networks. According to some examples, the client computing devices may be smart TVs, TV plug-ins, or the like that are capable of obtaining and/or transmitting information via the Internet or other networks. For example, an establishment may have one or more smart TVs that are capable of transmitting information to server computing device 130 and/or storage system 140 via network 120. The information may be, for example an indication of one or more events or programs that are scheduled to be played at the establishment or is currently playing at the establishment.

Storage system 140 may store various types of information. For instance, the storage system 140 may store data or information related to POIs for retrieval in response to a search for content to be played at the POI. As used herein, POIs may include any location, establishment, or destination, that a user can visit, such as a bar, restaurant, theater, park, etc. The POI information may include, for example, contact information, hours of operation, ratings, etc. associated with the POI.

According to some examples, the POI information may further include content information for one or more events or programs that are scheduled to be played at the POI, such as televised sporting events. The content information may be received via a communication channel over network 120 between the POI, storage system 140, and/or server computing device 130. According to some examples, the content information may be received in response to a POI updating their POI profile to include an indication of what is or will be broadcast.

In some examples, the content information may be received via a communication channel over network 120 between the output device at the POI and the server computing device 130 and/or storage system 140. For example, the output device may be a client computing device, such as a TV, display, etc. that is capable of obtaining and/or transmitting information via network 120. The output device may transmit an indication regarding the content being played, such as the channel the output device is tuned. Based on the indication, the storage system 140 and/or server computing device 130 may store an indication of what content is being played and updated the POI profile automatically.

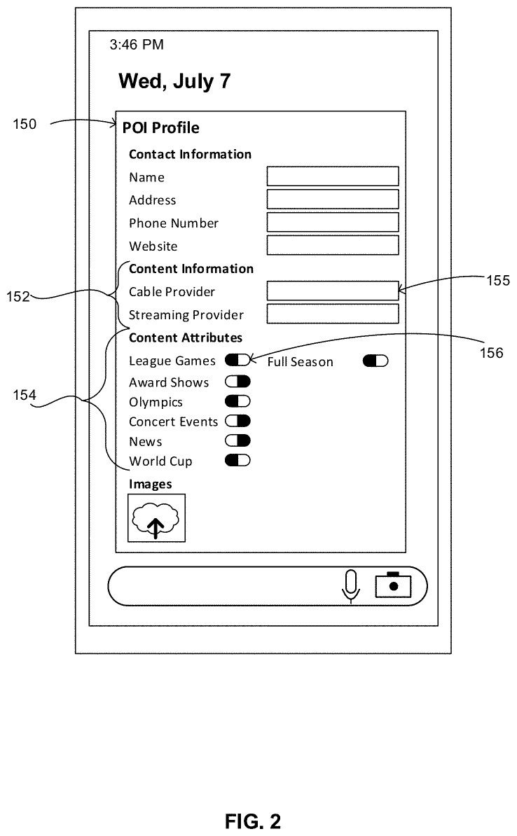

According to some examples, the POI information may be associated with a POI profile, shown in FIG. 2. The POI profiles may be updated by the POI and stored by storage system 140. As shown in the POI profile 150, the content information may be determined based on the content provider information 152 in the POI profile 150. The content provider information 152 may be an indication of the cable provider and/or streaming provider used by the POI. Based on the cable provider and/or streaming provider, the system may be able to determine what channels the POI has access to and use that information to determine what content the POI is capable of broadcasting. As shown, the POI may input text into a text box 155 indicating their service provider and/or streaming provider. While a text box 155 is shown to allow the POI to provide information regarding their content provider, some user interfaces may include buttons, drop downs, check boxes, etc. that can be selected by the POI.

According to some examples, the content information may be determined based on content attributes. The content attributes may be, in some examples, Boolean attributes. Boolean attributes may be attributes related to the content that is or is intended to be broadcasted. According to some examples, the attributes may be attributes that can be “true” or “false.” For example, the attribute may be “World Cup” and the POI either is/intends to broadcast the World Cup or is not/does not intend to broadcast the World Cup. In such an example, a response that the POI is/intends to may correspond to “true” while a response that the POI is not/does not intend to may correspond to “false.”

The POI may, in some examples, answer content attributes 154 via their POI profile 150. For example, a POI may provide a yes or no answer to whether they will be broadcasting certain events, programs, leagues, etc. during a given period of time. For example, a POI may answer a content attribute 154 querying whether the POI will be broadcasting certain league games for a period of time, such as a season or tournament. In one example, based on an answer to a first content attribute 154, such as whether the POI will be broadcasting league games, a subsequent content attribute may appear, such as whether the POI will be broadcasting league games for the full season. In some examples, the subsequent content attribute may query whether the POI will be broadcasting a specific game, or event, such as a tournament.

As shown, the POI may toggle 156 between yes and no when answering content attributes 154. While a toggle 156 is shown to indicate whether the POI will be broadcasting certain content, some user interfaces may include buttons that can be selected by the POI. The buttons may include an option for “yes” and another for “no.” In some examples, there may be a drop-down menu providing options for the POI to select. Additionally or alternatively, there may be check boxes that may allow the POI to select certain content, times during the day they will be broadcasting that type of content, etc. Therefore, while a toggle 156 is shown, a toggle 156 is just one option for the POI to indicate whether they are broadcasting certain content.

In some examples, the response to content attributes may be determined automatically, without the POI interacting with the content attributes. For example, the response to content attributes may be determined based on the cable or streaming package associated with the POI. The responses to the content attributes may be determined and used after the POI provides authorization for the system to access or receive information related to the POI's cable or streaming package. Any use of the POI's cable and streaming information is authorized by the POI. For example, the POI may provide authorization to an application for generating the POI profile and identifying content information by setting certain permissions for the application. The authorization may be for the application or system to access one or more databases or sub-databases in the memory of the output devices. In some examples, the authorization may be for the application or system to access a streaming device or cable box associated with the output devices.

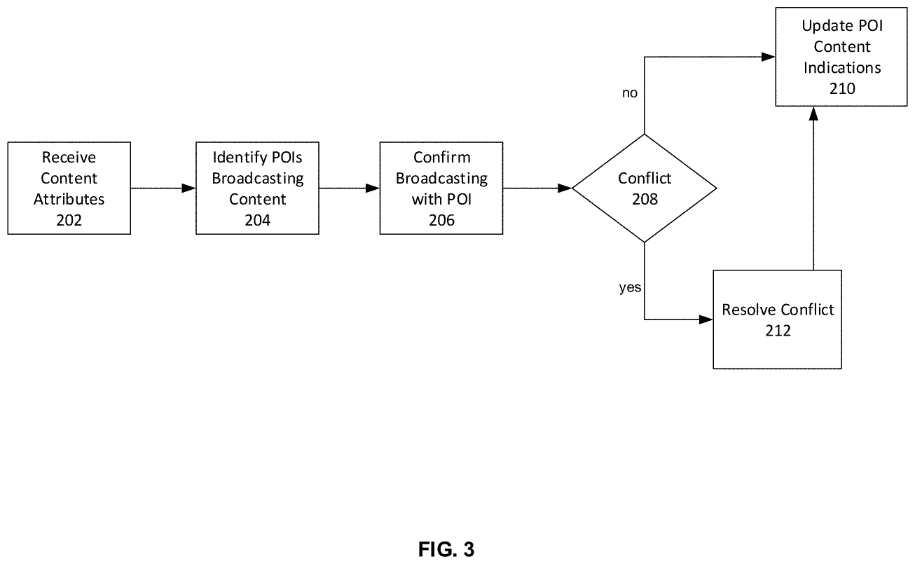

FIG. 3 illustrates an example method of updating content indications for POIs. The content indications may be information related to what content a POI is broadcasting or intends to broadcast. For example, the system may receive the content attributes from the POIs 202, identify POIs broadcasting certain content 204, confirm broadcasting with the POI, determine if there are any conflicts regarding the content information 208, and update the content information 210 to be displayed in response to a search result.

Receiving content attributes 202 may include, for example, receiving information from storage system 140, server computing device 130, and/or a client computing device of the POI. The content attributes 202 may provide an indication of what content, type of content, period of time, etc. a POI will broadcast. For example, a POI may have answered one or more content attribute questions in a POI profile to provide an indication of what the POI will be broadcasting.

The content attributes of the POIs may be used to identify one or more POIs that are or intend to broadcast certain content 204. For example, the content attributes of the POIs may be used to identify POIs that are or intend to broadcast the world cup, award shows, concert specials, etc. According to some examples, the identifying POIs broadcasting content 204 may include identifying POIs that are capable of broadcasting the certain content. For example, the system may, after confirming authorization from the POI, receive information related to the POI's cable or streaming provider. Based on the cable or streaming provided, the system may determine whether the POI has access to the requisite cable or streaming channel to broadcast the certain content.

According to some examples, the system may confirm that the POI is or intends to broadcast the certain content 206. For example, the system may transmit a message to the POI via the POI profile to confirm whether the POI is or intends to broadcast the World Cup, or any other specific content. In some examples, the system may automatically call, text, e-mail, or otherwise contact the POI based on the contact information provided in the POI profile and/or publicly available information related to the POI. The messages may ask the POI to confirm whether the POI is or intend to broadcast certain type of content, e.g., the World Cup, a specific showing of the type of content, e.g., a specific game of the World Cup, etc. The POI may choose to answer as many or as few questions regarding the content they are or intend to broadcast.

The system may determine whether there is a conflict 208. The conflict may be a conflict between the received content attributes 202, information in the POI profile, confirmation information provided by the POI 206, etc. For example, a given POI may indicate via a content attribute that they intend to broadcast the World Cup but, when seeking confirmation regarding the broadcasting the World Cup, the system may have received a response that the POI will not be broadcasting the World Cup on a given day in place of other content. In such an example, the content attribute indication, e.g., yes to broadcasting the World Cup, is in conflict with the confirmation information, e.g., no to broadcasting the World Cup.

In examples where there is a conflict, the system may resolve the conflict 212. Resolving the conflict may include, for example, identifying the most recent information related to the content that is or is intended to be broadcast at the POI. In some examples, this may be the confirmation information provided by the POI 206. In another example, the POI may not answer the confirmation message such that the most recent information is the content attribute 202 provided by the POI in the POI profile. According to some examples, the conflict may be resolved using a hierarchy, weighted system, sliding scale, direct comparison, etc. to resolve the conflict between information related to the content to be broadcasted at a POI. For example, a response to the confirmation message may be weighted greater than the content attribute, or vice versa. Once conflicts are resolved or if there are no conflicts, the POI content indication may be updated 210. Updating the POI content indication may include updating the information related to what content the POI is or intends to broadcast. According to some examples, if there is no conflict, the POI content indication may be confirmed, in addition to or instead of being updated.

The POI content indication may be provided in response to a search query. For example, a user may submit a search query seeking to find a POI that will be broadcasting the World Cup. The system may identify relevant POIs in response to the search query based on the POI content indications. In response to the search query, the system may provide the identified POIs for output to the user. The output may include, in some examples, POI information, including the content indications.

The POI profile 150 may include additional inputs to allow a given POI to add or update information related to the POI. For example, the POI profile 150 may include inputs to allow the POI to provide contact information, such as the POI name, address, phone number, website, social media, etc. In some examples, the POI profile 150 may include inputs to allow the POI to upload content, such as images, videos, etc. related to the POI. Information and content provided by the POI in the POI profile 150 may be provide in response to a search query for one or more POIs.

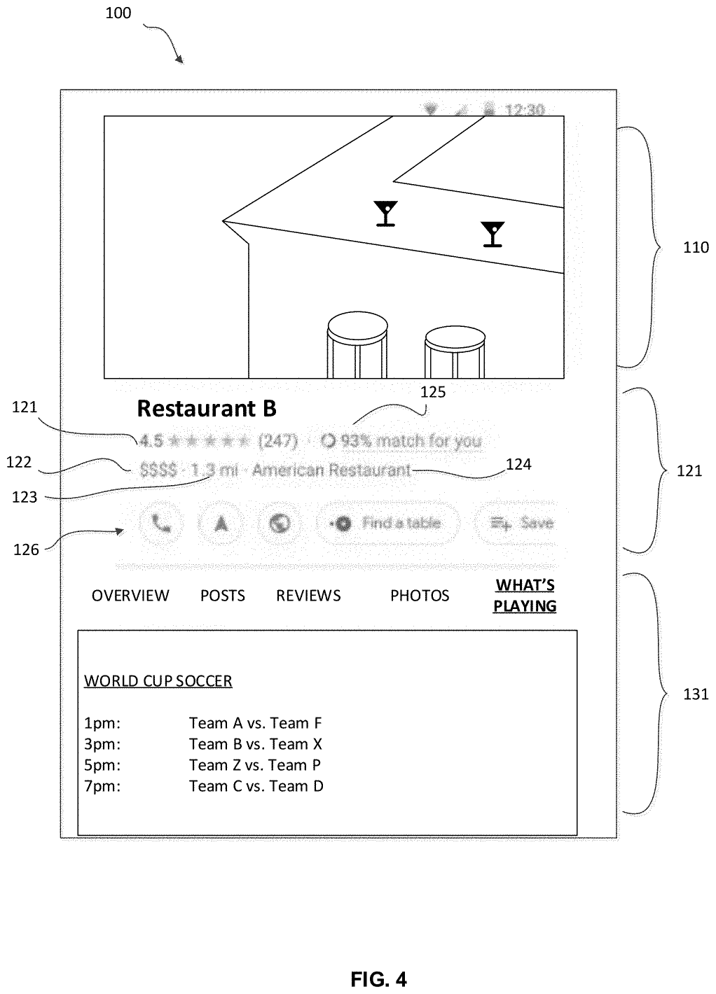

FIG. 4 illustrates an example display providing a content indication 131 of what will be played at an establishment. In this example, graphic 100 includes an image section 110, a summary information section 121, and a content indication section 131. The graphic 100 may be displayed, for example on a client device, in response to a request for information related to Business A. The request for information may include, for example, an address, business name, general geographical area, type of business, etc. For example, a user may have submitted a search for a restaurant, and selected a search result corresponding to Restaurant B.

Image section 110 may include an image relevant to the place. For example, for Restaurant B the image may be of the inside or outside of the restaurant, etc.

Summary information section 121 may include a variety of information describing the place. By way of example only, for Restaurant B such information includes a rating 121, a price category 122, a distance 123 from a particular location (e.g., the user's location), a categorization 124 of the type of food served, and a personal score 125 indicating how well the place matches the user's preferences. The summary section 121 may also include one or more links 126, facilitating actions by the user in connection with the place. For example, the links 126 may enable the user to call the place, get directions to the place, visit a website of the place, reserve a table at the place, save the place to one or more personal lists, etc. The foregoing are merely examples, and it should be understood that the summary information section 121 may include any of a number of other types of information. For example, the summary information section 121 may also include text, such as a listing of the operating hours of the Restaurant B.

Content indication section 131 may include an identification of content that will be played at the place. The indication may be, for example, a schedule, list, or any other format. The content may be, for example, sports games or matches, or any other televised or broadcast event, such as a news program, podcast, etc.

According to some examples, content indication section 131 may be a subsection that can be selected from a variety of options, such as overview information, posts, reviews, photos, etc. While a number of example sections are described above in connection with FIG. 4, and the content indication 131 is displayed as a schedule for a particular tournament, the World Cup, it should be understood that these are merely examples. The content indication 130 may be provided for display in any of a number of ways, such as text, pictorial diagrams, charts, graphs, etc. As described in further detail herein, the content indication 131 may also include a link to further information related to the content being played. For example, the further information may include a description of the teams playing, player information, statistics, standings, channel that is broadcasting the game, etc.

The content indication 131 may be based on a POI profile 150 created by the establishment. The POI profile may include images to be output in image section 110, information to be output in summary information section 120, and content information to be output in content indication section 131. The establishment may update their POI profile to indicate what content is going to be broadcasted and/or what content is currently being broadcasted at that establishment. In some examples, the POI profile and/or content indication section 131 may be updated automatically based on information provided by the output devices at the establishment.

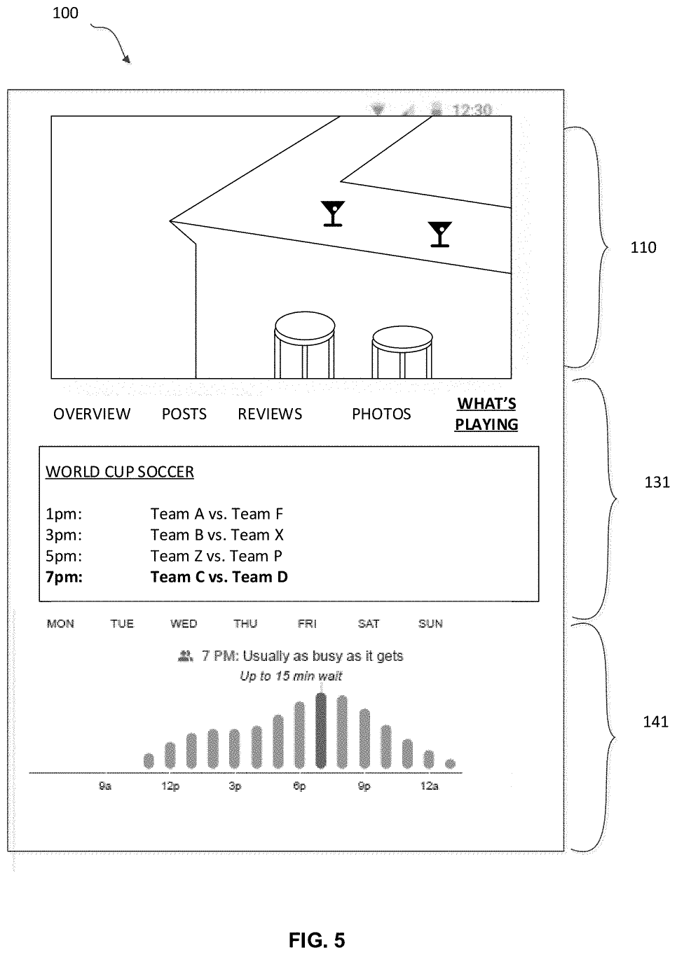

FIG. 5 illustrates one example of a type of further information that may be displayed upon user interaction with the content indication section 131. In this example, the further information includes busyness information 141 for the place. The busyness information 141 corresponds to a selection made by the user interaction with the content indication section 131. For example, the user may select the 7 pm game of Team C vs. Team D, such as by clicking, tapping, hovering, providing speech commands, etc. In response, the busyness information 141 corresponding to the selection, in this example 7 pm, is displayed. Such busyness information 141 may allow the user to gauge how crowded the place is likely to be during the game they want to watch. In this regard, the additional information allows the user to assess how comfortable they would be watching the selected game at the place.

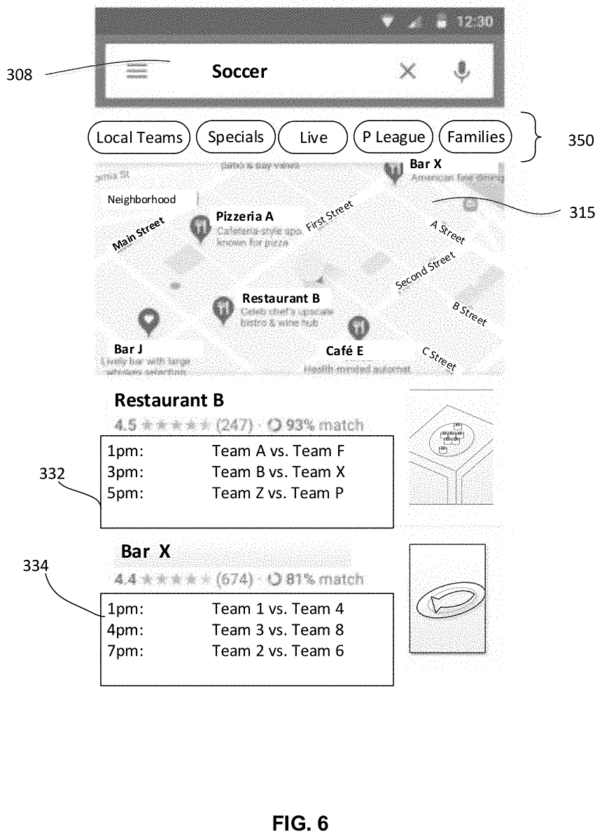

FIG. 6 illustrates an example of providing content information for a plurality of search results. A user enters a search 308, in this example “Soccer.” According to some examples, the user may identify a particular geographic region to search. According to other examples, if the user has provided her location, either explicitly or by authorizing location sharing on her client device, map 315 may automatically depict a region around the user's location. The map 315 may also include a depiction of geographical objects at the particular geographic location surrounding the user 305. For example, the geographic objects may include roads, buildings, landmarks, statues, street signs, etc. The objects may be depicted in, for example, a roadgraph, aerial imagery, street level imagery, or the like.

Places responsive to the user's search, such as places showing televised soccer games within a predetermined geographical range of the user's location, are identified. The search results may also be represented on the map 315, such as by marker points.

As shown, the search results may also be listed below the map 315, and the listing may include content information 332, 334 for each result. A shown in this example, the content information 332, 334 may be different for each results. The content information for the various results may be provided in a same format, or in a different format selected by an owner, operator, or authorized representative of the place. While the content information for the place may include much more information, such as games or matches for other types of sports, on other days, etc., the content information displayed with the search results may be filtered such that only the most pertinent information with respect to the search query is displayed. The results may be ranked, for example, based on how closely they match the user's request, how closely they match the user's predefined preferences, and/or how closely they match any of a variety of other parameters.

According to some examples, predefined filters 350 may be provided. The user may interact with any of the predefined filters 350, including multiple selections, to narrow down the search and displayed results. In this example, the predefined filters 350 include “Local Teams,” “Specials,” “Live,” “P League,” and “Families.” The “Local Teams” filter may restrict the search results to indicate only places that are playing content associated with local teams, such as games for teams associated with the geographic region displayed in the map 315. The “Specials” filter may narrow the results to only establishments providing some type of food, drink, or other special. According to some examples, if this filter is applied, additional information describing the type of special may be displayed in the search results along with the business information and content information. The “Live” filter may narrow the search results to only sporting events that are being broadcast live, as opposed to replays of older broadcasts. The “P League” filter may narrow the search results to a particular league, team, club, or the like. For example, the filter may suggest a particular league, team, club, etc. based on popularity for the geographic region or based on any other criteria. The “Families” filter may limit the search results to only those place that are appropriate to bring families. While a number of example filters 350 are illustrated in FIG. 6, it should be understood that these are merely examples, and that any of a variety of filters may be displayed, and additional or fewer filters may be displayed. In some examples, the filters may be determined based on the search 308 entered in the search field.

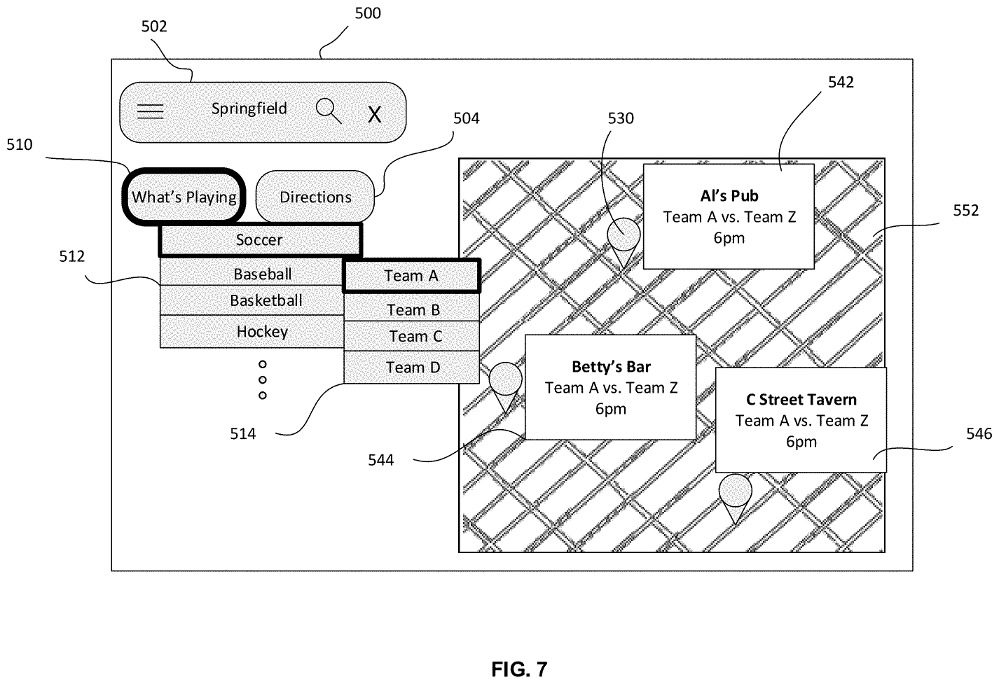

FIG. 7 illustrates an example interface 500 for searching and displaying content to be played at establishments within a particular geographic region. Interface 500 includes a geographic search field 502 and a map portion 552. The geographic search field 502 may be capable of accepting input indicating a geographic region. Examples of such input may include, without limitation, a town, city, zip code, particular POI, or instruction to use a current location of a user device, such as “near me.” When such input is entered into the search field 502, the map portion 552 may display the geographic region corresponding to the input. For example, if the city of “Springfield” is entered into the search field 502 as shown in FIG. 7, a map of Springfield may be displayed in the map portion 552. Such map may take any of a variety of forms, such as a traditional two-dimensional roadway depiction map, a bird's eye view map, satellite view, street-level view, three-dimensional view, etc.

In the example shown, the screenshot 500 includes a plurality of request buttons 504, 510 through which commands can be received to perform a particular action. By way of example, “directions” request button 504, when selected, may cause a prompt to appear seeking input of a starting point such that driving, walking, public transportation, or other directions to the geographic region can be generated from the starting point. “What's playing” request button 510, when selected, may cause an indication of places playing particular content within the geographic region to surface on the map portion 552. According to some examples, particular timeframes for the content may be received as input from a user, and the search results are filtered such that only places with content playing within the particular timeframes are indicated in the map portion 552. For example, the user may indicate that the search is for sporting event be played “now,” “today,” “tonight,” “tomorrow,” “next month,” or any other timeframe. In response, the search results may depict the content being played within the specified timeframe.

According to some examples, the search request may be filtered, such as to provide places playing only particular types of content specified in a request from the user. In the example shown, a pre-populated menu may be displayed offering options for selection. Such options may include, for example, content type and sub-type. For example, the pre-populated menu can be a hierarchical drop-down menu as shown in FIG. 7 with a main menu 512 and one or more sub-menus 514. In this example, the main menu 512 includes a variety of content types, such as different sports. It should be understood that these are merely examples and other types of content may be included in the menu.

When a type is selected from the main menu 512, such as selection of “soccer,” a sub-menu 514 may be displayed providing a variety of sub-types that correspond to the selected type. For example, for the main type of soccer, the sub-types in sub-menu 514 may include specific teams. According to other examples, the sub-types may include particular leagues or any other category. According to some examples, even further refinement is possible. While the pre-populated menu in this example is a hierarchical drop-down list, it should be understood that any of a variety of other menu formats are possible. For example, the menu may include a collection of icons, text bubbles, etc.

Results for the search may be displayed in the map portion 552. The results may be indicated in any of a variety of forms. In the example of FIG. 7, the results are indicated as pins 530 with corresponding information boxes 542, 544, 546. According to some examples, an amount of information surfaced may vary based on a number or density of results. According to some examples, information boxes 512, 544, 546 may be displayed only for events most closely matching user preferences, while other events retrieved in the search are displayed with less information, such as location pins only. The results may be displayed and updated each time an event type or sub-type is selected. For example, while many events may be displayed in response to a selection of soccer, the map portion 552 may be updated to display fewer results when the sub-type of “Team A” is selected.

The information boxes 542, 544, 546 may display any of a variety of types of information. As shown, the information boxes 542, 544, 546 display a name of the establishment showing the content and an indication of what content is being played and when. For example, because the search specified Team A, the information boxes 542, 544, 546 may limit the information displayed to information that includes Team A. According to other examples, more or less information may be displayed.

According to some examples, in response to user interaction with one of the information boxes 542, 544, 546, more detailed information may be displayed. Examples of such detailed information may include capacity, an actual or predicted busyness level for the event, links to a website for the venue, description of the venue, such as ambiance, décor, noise level, vibe, etc., or any of a variety of other information. The capacity may indicate a number of people that the venue can accommodate. Such information may give the user a sense of how crowded the venue will be for the event. Some users may feel less comfortable around large crowds, for example, and prefer smaller venues. The remaining availability and busyness level for the event may provide similar indications regarding how crowded the event will be. Due to this, improved safety information is provided as part of the search results as the user is informed how busy the venue or area is. The busyness information may indicate how many people were or will be at the event. The busyness information can be illustrated using a picture captured at the venue, using a graph illustrating levels of busyness for the venue at various times, or by any other mechanism. In an example, preferences may be predefined by the user such that search results that are objectively less relevant to the user may be automatically displayed in a less prominent manner That is to say, a more detailed information box may not be displayed automatically for search results that do not match the users preferences, and may only be displayed automatically for search results that do match the users preferences. The automatic reduction in display prominence of objectively less relevant search results improves both the use of screen space and processing efficiency of displaying the search results, since results that are objectively less relevant to the user are displayed in a reduced manner. As such, relevant search results may be displayed more efficiently, quickly and clearly.

The information boxes illustrated in FIG. 7 are just one example of how details can be displayed for a particular place and the content being played at the place. In other examples, information can be output in any of a variety of other formats.

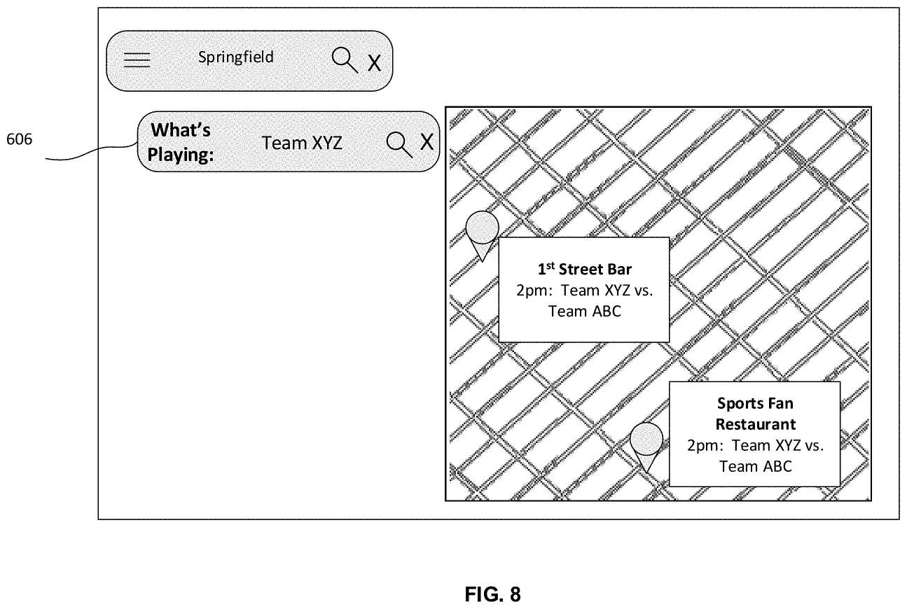

FIG. 8 illustrates another example of a search tool for content to be played at businesses or other nearby establishments, and how search requests can be entered using the tool. In this example, rather than a pre-populated menu, a free-text search field 606 is provided. Such free-text search field 606 may accept search queries having varying level of details. For example, the field 606 can accept a general request such as “all” live sporting events being played at local establishments. In other examples, such as the one illustrated, the field 606 can accept more specific request, such as for establishments playing match featuring Team XYZ. In response, businesses within the geographic region are displayed that are showing Team XYZ on their televisions.

Information used for surfacing the events, such as the match featuring Team XYZ of FIG. 8, may be collected from owners of the establishments or authorized representatives. For example, an owner or employee of the bar/restaurant showing Team XYZ may create an entry in a profile, map database, or other data structure listing the content they intend to play at particular times, such that it can be included in search results. When creating the entry, the owner or representative's identity may be verified, such that only owners or authorized representatives can publish information regarding the content to be played at the establishment. According to other examples, members of the public may be authorized to create such entries and/or provide updated information. According to some examples, information supplied by the general public may be accepted as suggestions that must be confirmed by the owner or an authorized representative.

According to some examples, the content to be played at a particular establishment may be automatically provided. For example, if the establishment subscribes to a particular channel or broadcast, content information for the establishment may indicate whatever is being played on that particular channel or broadcast. According to another example, if the establishment always plays games for a specific team, the content information may be automatically updated to include games for the specific team.

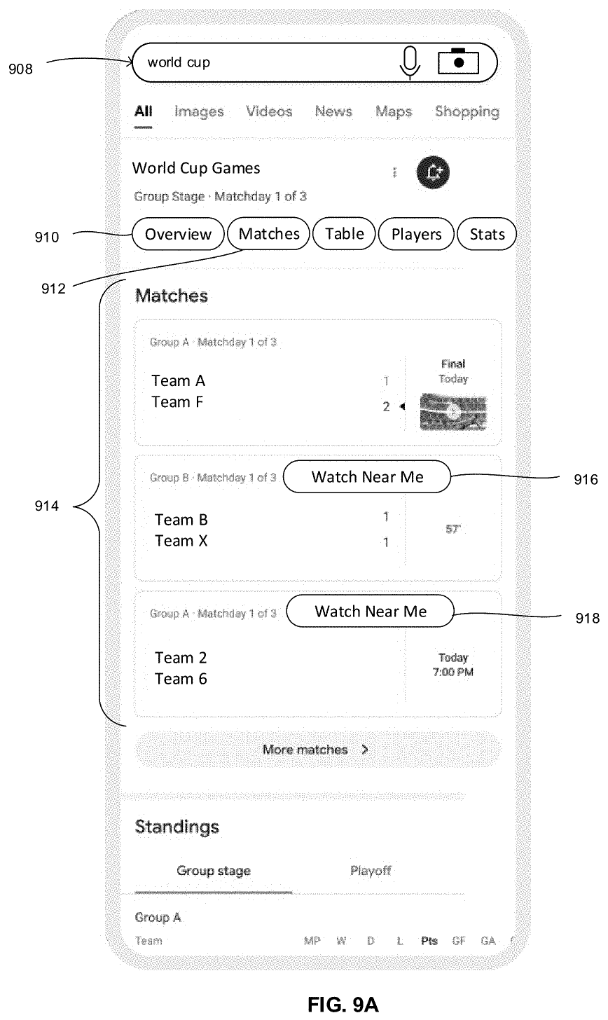

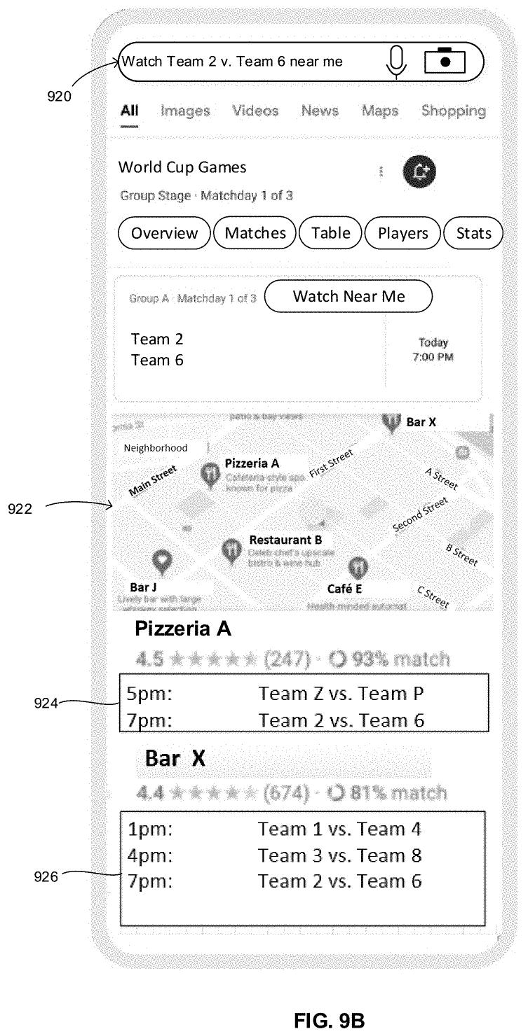

FIG. 9A illustrates an example of providing search results. A user enters a search 908, in this example “world cup.” The system may determine the intent of the search. For example, the system may determine that the World Cup is going to start in two weeks. In response to the search 908, the system may identify the intent to be preparations for the World Cup. The search results may, in such an example, pertain relevant information for preparing for the start of the World Cup. In some examples, such as the one shown in FIG. 9A, the system may determine that the World Cup is currently being played. In such an example, the system may determine the intent of search 908 to be information about the games being played at or around the time of the search. For example, in response to the search “world cup,” the system may provide information regarding the matches that have recently been completed, such as the match between Team A and Team F, the match currently being played between Team B and Team X, and the next match to be played between Team 2 and Team 6.

According to some examples, included with the search results may be a number of inputs related to the search results. For example, a user can narrow or filter the search results to focus on an overview 910 of the World Cup, a list of matches 912 to be played, table, player, stats, etc. In response to receiving an input corresponding to the selection of matches 912, the system may provide an output 914, such as a list, of matches that have or will be played. An input 916, e.g., “watch near me,” may be provided with the results. The “watch near me” input 916, 918 may cause a subsequent search to be performed to identifying one or more establishments that have indicated that they are or that they intend to broadcast content related to the search results. For example, the system may receive an input corresponding to the selection of input 918. The system may search for establishments that intend to broadcast the match between Team 2 and Team 6. According to some examples, the system may search for establishments in a predetermined geographic area near the user.

FIG. 9B illustrates an example of providing search results in response to receiving an input corresponding to the selection of “watch near me.” As shown, the search 920 may update from “world cup” to “Watch Team 2 v. Team 6 near me” in response to receiving a selection of input 918. Places response to the updated search 920, such as places showing Team 2 v. Team 6, within a predetermined geographical range of the user's location, are identified. The search results may be represented on a map 922, such as by mark points. As shown, the search results may also be listed below the map 922, and the listing may include content information 924, 926 for each result. The identified establishments, e.g., Pizzeria A and Bar X, have content information 924, 926 that indicates that they intend to broadcast the match between Team 2 and Team 6.

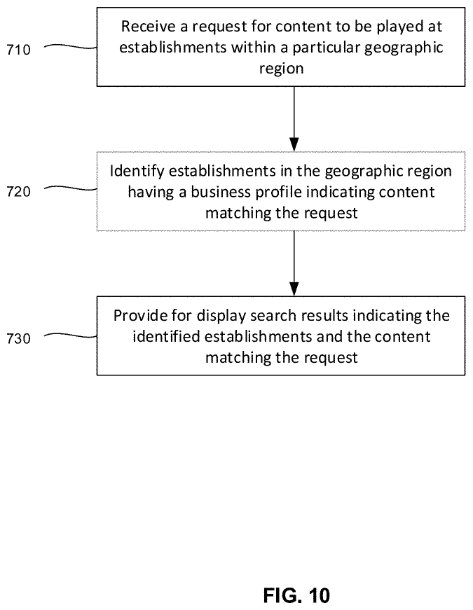

FIG. 10 illustrates an example method of displaying temporal events in association with geographic locations. While the operations are described in a particular order, it should be understood that operations may be performed in a different order or simultaneously. Moreover, operations may be added or omitted.

In block 710, a request is received for content being presented or to be presented at establishments within a particular geographic region. For example, the request may specify a particular town, street, city, state, country, postal code, coordinates, landmark, or any other information that may be used to identify a geographic region. The content may include, for example, televised sporting events or any other events broadcast over television, radio, or other channels. The events may be live in-person, live streamed or televised, time delayed, previously recorded and replayed, etc. For example, the events may include sports games, performances such as music, theatre, dancing, or any other type of event. The request can be general, such as for “basketball,” or it can be more specific, such as for a specific team playing at a particular time.

In block 720, establishments are identified having locations within the geographic region and business profiles indicating content matching the request. For examples, establishments can each update their associated business profiles to identify particular tournaments, matches, games, or other events that the establishment will play for its customers to watch or listen. In other examples, the business profiles can be updated automatically. The search request can be compared with the information in the business profiles to identify a match.

According to some examples, identifying the establishments includes receiving content attributes from the establishments. The content attributes may be an indication of whether the establishment is or intends to broadcast a certain type of content or a specific broadcast of the type of content. For example, the content attribute may be an indication that the establishment intends to broadcast college basketball. A specific broadcast of the type of content may be a specific college basketball game, such as two teams playing against each other at a given time. The content attributes may be received from POI profile information. According to some examples, the content attributes may be received in response to questions transmitted to the establishments.

The content attributes may be compared with the request for content. For example, if the request for content is for “music awards shows,” the system may compare the content attributes of the establishments with “music awards shows” to determine which establishments have indicated that they are or intend to present content related to music award shows. The establishments whose content attributes indicate that they intend to present content related to music awards shows may be the identified establishments.

According to some examples, a confirmation message may be transmitted to the establishments. The confirmation message may be based on the content attributes and/or the request for content. The response to the confirmation message may be a confirmation or denial that the establishment is or intends to present a type of content or a specific broadcast of the type of content. For example, the content attributes of an establishment may indicate that they intend to present content related to football and, more specifically, football games played be a specific team, such as Team W. A confirmation message may be transmitted to the establishment to confirm or deny the content attribute. For example, the confirmation message may ask the establishment to confirm they intend to present football games played by Team W. The confirmation may be sent by, for example, email, text, facsimile, phone, or through any other type of communication channel. The establishment may provide a response, such as a yes or a no. In some examples, the confirmation message may be sent to a user having a location corresponding to the location of the establishment. For example, a patron of a bar may volunteer to answer questions about what media content is being broadcast at the bar while the patron is present. When a user searches for establishments broadcasting a particular event, if the bar is returned as a result the user may submit a request for verification. The request for verification may be sent to the patron located at the bar, who may in turn provide a response based on what the patron observes, the response indicating whether or not the particular event is being broadcast.

The response of the confirmation message may be compared to the content attributes to determine if there is a conflict. A conflict may be, for example, if the content attribute indicates that the establishment intends to present content related to Team W but the confirmation messages indicates that the establishment is not going to present content related to Team W. In such an example, the conflict may be resolved based on which of the content attribute or confirmation message was most recently received. In some examples, the conflict may be resolved by using a hierarchy, weighted system, sliding scale, direct comparison, etc. Once the conflict is resolved, the content information for the establishment may be updated. In examples where there is not a conflict, the content information may be updated and/or confirmed with the content attribute and/or confirmation message.

In block 730, search results may be provided for display indicating the identified establishments and the content matching the request. For example, if the request is for a particular basketball team, the search results may indicate each establishment playing the game for that basketball team. According to examples, other information may also be provided, such as other events being played by the establishment, venue information related to the establishment, etc. The search results may be displayed in any of a variety of formats, such as on a map, in a list, etc.

According to some examples, the business profiles for respective establishments can be automatically updated to remove a listing of the event when the event is over. For example, if the business profile lists that the establishment will present games 1, 4, and 10 out of a sporting contest that includes 10 consecutive games, the business profile may be automatically updated to remove a listing for game 1 when game 1 is over, and then to remove the listing for game 4 when game 4 is over, etc.

Providing for searching and displaying of establishments playing particular content as described above is beneficial in that it provides pertinent information to users in a computationally efficient manner. In particular, rather than requiring a user to search for locations, and then visit websites for each location to determine what games are being played at a particular time, the user can search for all content that will be played at establishments in a particular area with one search command. In this manner, the user is automatically shown those events that are occurring in the relevant time frame as part of the search results, providing a dynamic and relevant search. By reducing the number of sites needed to visit for such information, computing resources such as bandwidth, power, and other network resources are conserved. Moreover, the system and method provided herein provide for applying specific filters that may be implicit or explicitly set by the user. By filtering the results prior to display, and thereby reducing the number of less pertinent results displayed, additional computing resources are conserved as only the filtered results need be rendered and displayed on a user device.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A method, comprising:
receiving, with one or more processors, a user request for a specific sporting event to be presented at establishments within a particular geographic region;
receiving, with the one or more processors, information from the establishments within the particular geographic region, the information for each establishment indicating which sporting events will be presented at the respective establishment;
updating, with the one or more processors, a respective business profile for the respective establishments based on the information;
identifying, with the one or more processors, matching establishments in the particular geographic region, wherein the business profile for each of the matching establishments indicates that the specific sporting event will be presented; and
providing for display, with the one or more processors, search results indicating the matching establishments and the specific sporting event to be presented.

2. The method of claim 1, wherein the sporting event is broadcast through a television network or streaming service.

3. The method of claim 1, wherein receiving the information from the establishments comprises:
transmitting, with the one or more processors, a content request message to one or more of the establishments; and
receiving, with the one or more processors, a response to the content request message.

4. The method of claim 1, wherein providing the search results for display comprises providing a graphic for each result as an overlay on a map.

5. The method of claim 4, wherein the graphic includes information indicating the specific sporting event to be presented at the establishment.

6. The method of claim 1, wherein the content comprises at least one of live in-person events, live virtual events, time delayed or replayed events.

7. The method of claim 6, wherein the live virtual events are televised or streamed events.

8. The method of claim 1, further comprising automatically updating the respective business profile based on the sporting event to be presented at the respective establishment.

9. The method of claim 8, wherein automatically updating the respective business profile comprises removing sporting events from a portion of the business profile listing sporting event to be presented, wherein the removing is performed after the sporting event has ended.

10. A system, comprising:
one or more memories; and
one or more processors in communication with the one or more memories, the one or more processors configured to:
receive a user request for a specific sporting event to be presented at establishments within a particular geographic region;
receive information from the establishments within the particular geographic region, the information for each establishment indicating which sporting events will be presented at the respective establishment;
update a respective business profile for the respective establishments based on the information;
identify matching establishments in the geographic region, wherein the business profile for each of the matching establishments indicates that the specific sporting event will be presented; and
provide for display search results indicating the matching establishments and the specific sporting event to be presented.

11. The system of claim 10, wherein providing the search results for display comprises providing a graphic for each result as an overlay on a map.

12. The system of claim 11, wherein the graphic includes information indicating the specific sporting event to be presented at the establishment.

13. The system of claim 10, wherein the content comprises at least one of live in-person events, live virtual events, time delayed or replayed events.

14. The system of claim 13, wherein the live virtual events are televised or streamed events.

15. The system of claim 10, wherein the one or more processors are further configured to automatically update the respective business profile based on the sporting event to be presented at the respective establishment.

16. The system of claim 15, wherein automatically updating the respective business profile comprises removing sporting events from a portion of the business profile listing sporting event to be presented, wherein the removing is performed after the sporting event has ended.

17. The system of claim 10, wherein in receiving the information from the establishments the one or more processors are further configured to:
transmit a content request message to one or more of the establishments; and
receive a response to the content request message.

18. A computer-readable medium storing instructions executable by one or more processors for performing a method, comprising:
receiving a user request for a specific sporting event to be presented at establishments within a particular geographic region;
receiving information from the establishments within the particular geographic region, the information for each establishment indicating which sporting events will be presented at the respective establishment;
updating a respective business profile for the respective establishments based on the information;
identifying matching establishments in the particular geographic region, wherein the business profile for each of the matching establishments indicates that the specific sporting event will be presented; and
providing for display search results indicating the matching establishments and the specific sporting event to be presented.

19. The non-transitory computer-readable medium of claim 18, wherein providing the search results for display comprises providing a graphic for each result as an overlay on a map, wherein the graphic includes information indicating the specific sporting event to be presented at the establishment.

20. The non-transitory computer-readable medium of claim 18, the method further comprising automatically updating the respective business profile based on the sporting event to be presented at the respective establishment, wherein automatically updating the respective business profile comprises removing sporting events from a portion of the business profile listing sporting event to be presented, wherein the removing is performed after the sporting event has ended.
